(19) United States
(12) Patent Application Publication
(10) Pub. No.: US 2006/0081153 A1
(43) Pub. Date: Apr. 20, 2006

(54) Color coat sanding guide

(76) Inventors: Brian Scott Stanley, Sumner, WA (US); Lauren Lorraine Buck, Sumner, WA (US)

Correspondence Address: Brian Scott Stanley, 15707 50th St. Ct. E., Sumner, WA, 98390, US

(21) Appl. No.: 10/967,556

(22) Filed: Oct. 18, 2004

(51) Int. Cl. B24B 1/00; C09D 7/00; C09B 67/00

(52) U.S. Cl. 106/287.35; 451/54; 8/527

(57) ABSTRACT

Color Coat Sanding Guide works better than other sanding guide products in the field of autobody and yacht building. Color Coat Sanding Guide is a non-flammable liquid and not a powder or spray can type of sanding guide. Liquid Color Coat Sanding Guide carries a dark dye with it that gets deposited down deep into surface imperfections. It allows the person who is sanding the surface the luxury of being able to actually see the very scratches that need to be removed. Once all of the finest scratches and imperfections are removed, the boat or car can be either buffed shiny or top coated with a perfect finish.

### BACKGROUND OF THE INVENTION

In the field of yacht building and in the related field of autobody, polyester gelcoats and autobody primer type paints are used to create a finish that is scratch free. To create a scratch free surface that could be buffed to a shiny surface one must sand the imperfections off of the gelcoat or primer.

Today dry sanding paper is available in all of the desired coarseness to create a shiny surface. The use in autobody and yachtbuilding of dual action air powered sanders and dry sandpaper has sped up the production time in both of these related fields.

The problem that occurs in sanding gelcoats and primers is that the person needs excellent lighting in order to see the sanding scratches, pinholes and other imperfections in the surface to be sanded. Most yachts have white polyester gelcoats and the primers used in autobody tend to be light colored not dark. When sanding light colored surfaces a dark sanding guide could be used.

I know of two different tools or guides used to help solve this problem of seeing the imperfections. One uses a common dark colored spray can found in most hardware stores. The method used is to lightly mist the dark spray paint onto the surface to be sanded. When the speckle coat of paint dries (sometimes taking a long time) the person dry sands the speckles off of the surface. It is assumed that when the speckles are gone the scratches are gone. However, the speckles did not find all of the scratches because a speckle coat is not a complete coat in that there are spaces between paint drops in the speckle coat.

The other tool used in the prior art to help identify imperfections is made of a dark powder. The method used is to wipe the dark powder onto the surface to be sanded using a soft foam applicator. This tool works better than the canned spray paint because it is finer in appearance and does not need to dry before sanding. However, because it is a powder the mostly air powered sanding tools tend to blow away much of the powder. Even the powder that did manage to deposit itself down into the imperfections tend to be hard to see and lacking in definition because of lack of color density.

My invention is called “Color Coat Sanding Guide.” It is a non-flammable liquid that when shipped will not incur flammable related shipping charges. At the jobsite it is added to one gallon of acetone producing a sanding guide to be wiped onto the sides of yachts or in the autobody business on cars. The Color Coat Sanding Guide soaks down into all the imperfections and leaves a dark, easy to see, dust-free, fast drying guide for sanding.

### BRIEF SUMMARY OF THE INVENTION

The general idea of the invention is to use a non-flammable liquid dye to be mixed later with acetone at the job site for a sanding guide that has advantages over the other products on the market.

The advantages of Color Coat Sanding Guide over the previously mentioned sanding guides are that it will not incur flammable related shipping costs; it soaks down into all of the surface imperfections, not just some; it dries almost as fast as acetone (which is about the fastest drying liquid there is); it will not clog up sandpaper. In a wintertime shop the temperatures can be very low and canned spray paint does not completely cure, remaining sticky; it is darker than the powder type sanding guide and will not blow away when air powered dual action type dry sanding tools are used.

The object of the invention is to make the process of sanding light colored rough surfaces easy all the way to the point where you could buff the surface to a perfect shine.

### BRIEF DESCRIPTION OF THE SEVERAL VIEWS OF THE DRAWING

Not Applicable

### DETAILED DESCRIPTION OF THE INVENTION

In the previous art the person sanding the gelcoat or primer used reflected light either sunlight or high quality lighting. If the person sanding has good eyesight it is still difficult to detect the rough areas as apposed to the shinier areas. Only a seasoned sanding craftsman would be able to complete the sanding process correctly while using reflected light as the only sanding guide.

The development of the previously mentioned sanding guides made of sprayed on hardware store dark paint or dark colored powder is a step in the right direction for identifying imperfections while sanding light colored surfaces.

Because the other products in the previous art used canned spray paint or powders, Color Coat Sanding Guide is different in that it is a wipe-on non-flammable liquid sanding guide. It should be noted that the entire sides of 100 foot in length yachts or bigger could easily be coated with Color Coat Sanding Guide for very little cost to the yacht builder.

In the previous art using spray cans or powder, the technique of applying a sanding guide between the changing of sanding grits is used. Therefore, one may start off sanding an unsanded surface with a coarse sanding grit and then before changing to the next finer grit, wipe dark powder or mist lightly spray can paint onto the surface for the next finer sanding grit.

This process is similar to the process used when applying Color Coat Sanding Guide.

The process of making Color Coat Sanding Guide is simple. You must have an empty 8 oz. container for liquids and in a separate mixing bowl mix 3 tablespoons of Procion MX dye of the color Navy 078 with 7.7 oz. of 85 degree F. water. This powdered dye is available through Jacquard Products, P.O. Box 425, Healdsburg, Calif. 95448, U.S.A. The phone numbers for this company are: (707)433-9577 and 1-800-442-0455.

The mixture is then added to the empty 8 oz. liquid container which has instructions on its label. The label tells the user how the sanding guide is to be used.

The label explains how once the customer receives the non-flammable liquid the user will then add I/2 of the 8 oz. container of Color Coat Sanding Guide to a can half full of acetone for the proper color density and maximum performance. The mixture of 4 oz. Color Coat Sanding Guide and ½ gallon of acetone is hand shaken and then with rubber gloves applied to a small cotton rag. The soaked rag is wiped on the light colored surface to be sanded.

The reason a cotton rag is used is to insure that the acetone mixture does not dissolve the rag. Cotton does not dissolve in acetone.

The wiped on Color Coat Sanding Guide and acetone mixture dries fast and within seconds the sanding process may begin.

After the first pass over the sanded surface using the sanding grit of choice is completed and all of the dyed surface shows no more guide color, the person dusts off the surface and applies another coat of the Color Coat Sanding Guide and acetone mixture in the same manner as before. The next finer grit of sandpaper is then used to sand off all of the more coarse sanding scratches of the previous sanding grit. These coarse scratches will be removed when no more color from the guide is left on the surface.

The process of wiping on the mixture and sanding with the next finer sanding grit can be taken all the way to the point where the person sanding the surface can at last buff the sanded surface with a buffing compound to a shiny finished surface.

When using the Color Coat Sanding Guide and acetone mixture one should shake the container holding this mixture a few times per day because the dye component may settle a small amount over time. This will insure proper color density for maximum performance.

What I claim as my invention is:

1) An 8 oz. container of correct quantities of dye powder and water in the right sized container to create the correct color density when added to one gallon of acetone. This is a high quality sanding guide for light colored surfaces.

2) When used on fine sanding scratches such as 400 grit or finer, the Color Coat Sanding Guide will not blow off of the surface to be sanded when using air powered sanding tools. Because Color Coat Sanding Guide is applied as a liquid, it bonds better than a powdered guide.

3) Color Coat Sanding Guide is a non-flammable liquid when received by the customer. Therefore, there will be no flammable shipping charges. The customer must use acetone of their own to complete the mixture for use on sanding projects.
